(19) United States
(12) Patent Application Publication
(10) Pub. No.: US 2025/0022219 A1
(43) Pub. Date: Jan. 16, 2025

(54) A Method and Devices for Presenting 3D Scenes

(71) Applicant: BEIJING XIAOMI MOBILE SOFTWARE CO., LTD., Beijing (CN)

(72) Inventor: Emmanuel THOMAS, Beijing (CN)

(21) Appl. No.: 18/576,070

(22) PCT Filed: Jul. 2, 2021
(86) PCT No.: PCT/CN2021/104374

§ 371 Date: Jan. 2, 2024

(51) Int. Cl. G06T 17/00

(52) U.S. Cl. CPC G06T 17/00

(57) ABSTRACT

A 3D (three-dimensional) scene presenting method and associated devices use a shared reference document and a corresponding set of 3D update documents. When a presentation engine is triggered to access or present a target 3D scene among a set of target 3D scenes, it parses the shared reference document and the corresponding 3D scene update document among the set of 3D scene update documents to generate the target 3D scene description document describing the to-be accessed or presented 3D scene, renders the generated description document and updates the presenting 3D scene as the target scene.

### TECHNICAL FIELD

The invention is related to a 3D (three-dimensional) scene presenting method, in particular, a 3D scene presenting method enabling random access to a set of target 3D scenes.

### BACKGROUND

With the advent of 3D Computer Graphics in the 1990's, content creators were able to represent any real or artificial entity as a 3D object by describing its shape, texture and material. Thus, a 3D scene is a complex collection of moving 3D objects in a virtual environment with physical properties including lighting, viewpoint and sound and so on.

For presenting such a 3D scene to the user, a presentation engine may be employed to parse and render a 3D scene description document describing the node hierarchy, materials, cameras, animations, as well as all the other scene description data of the complete 3D scene. Generally, a 3D scene description document may be formulated by data formats such as JSON, XML, YAML and the like. Moreover, it is possible to update such a source data document into a target data document with an update document describing the to-be applied operations, e.g. add, remove, replace and so on, namely by using a patching method as shown in FIG. 1. If the data is formulated as a JSON document, the update document is a JSON patch document; if it is an XML document, the update document is an XML diff document.

Therefore, for updating a 3D scene, a presentation engine might parse and apply a corresponding 3D scene update document to the preceding 3D scene description document, generate and render a new 3D scene description document. As depicted in FIG. 2, by parsing and applying the update documents U12, U23, U34, . . . consecutively, the presentation engine may realize a sequential presentation of 3D scenes V1, V2, V3, . . . .

However, in this scenario, it is impossible to start the 3D scene presentation from a latter 3D scene (V2, V3, . . . ) which is not the initial scene V1, or skip some 3D scenes.

### SUMMARY

It is an object of the present invention to provide a 3D scene presenting method facilitating a random access to a set of target 3D scenes among the plurality of the 3D scenes to be presented (V1, V2, V3, . . . ).

In embodiments, a method for presenting 3D scenes determines that documents to be parsed for generating the set of target 3D scenes, namely a shared reference document and a corresponding set of 3D scene update documents for generating the set of target 3D scenes, are available. Wherein each target 3D scene among the set of target 3D scenes is described by a target 3D scene description document; a shared reference document describes part of the elements contained in the set of target 3D scene description documents; and each 3D scene update document describes the updates to be applied to the shared reference document for generating the corresponding target 3D scene description document. When the presentation engine is triggered to access or present a target 3D scene among the set of target 3D scenes, it parses the shared reference document and the corresponding 3D scene update document among the set of 3D scene update documents to generate the target 3D scene description document describing the to-be accessed or presented 3D scene, renders the generated description document and updates the presenting 3D scene as the target scene.

Since the generation of different target 3D scene description documents are realized by applying the update operations contained in corresponding 3D scene update documents to a common shared reference document rather than a preceding description document, the method as disclosed herein facilitates random access to any 3D scene included in the set of target 3D scenes. In a specific example, if users trigger the presentation engine to present a target 3D scene V7 (which we refer to as random access), the presentation engine will parse the shared reference document with the corresponding 3D scene update document to present V7 to the users directly instead of successively generating V1 to V6 documents and waiting until the presentation of V1-V6 is finished if rendering cannot be skipped.

It is preferred that a shared reference document may be different from a 3D scene description document whose size may up to a few megabytes. To be more specific, it may not describe a complete 3D scene or even a syntactically valid 3D scene, but only part of the elements already contained in the set of target 3D scene description documents. The minimum requirement for the shared reference document is that it is formulated in the same format as a 3D scene description document, and thus an update document can be applied to it and generate a valid 3D scene description document. In this case, the size of a shared reference document may be much smaller than a complete scene description document.

The shared reference document can also be a complete scene description document describing a 3D scene which is different from any 3D scenes to be presented while having the greatest average similarity to all the target 3D scene. Therefore, even though the size of the shared reference document might be a few megabytes, the overall size of the corresponding set of 3D update documents will be minimized.

In both cases, the additional size for enabling a random-access function in a 3D scene presentation will be minimized under a certain criterion, the memory resource for storing the 3D presentation with random access function can be saved. Additionally, when the 3D presentation needs to be downloaded from the internet, the downloading time and internet traffic can also be improved. In general the shared reference document can be generated such, that it provides the most efficient basis for generating all the target 3D scenes to be displayed, or at least for generating as many scenes as possible, whereby it could be e.g. any document having the greatest average similarity to all of the target 3D scene description documents.

In a preferred embodiment, the presentation engine might be triggered by any signal like wall-clock time (real time), presentation time or interaction event to access or present a target 3D scene. In this way, the random-access function can be implemented in different scenarios, and improving the user experience. The target 3D scene may be any of the set of target 3D scenes.

In another preferred embodiment, a shared reference document and a corresponding set of 3D scene update documents for generating the target set of 3D scenes may be first defined according to certain criterion, e.g. minimizing the size or minimizing the processing time.

In a preferred embodiment, for defining a shared reference document and a corresponding set of 3D scene update documents for generating the set of target 3D scenes, a candidate shared reference document and a candidate set of 3D scene documents may be first generated and evaluated according to certain criteria.

Optionally, a shared reference document and a corresponding set of 3D scene update documents for generating the set of 3D target scenes may be defined when the overall size of the set of 3D scene update documents is smaller than a first given threshold, like a few megabyte, or minimized. Therefore, the additional size for enabling the random-access function can be minimized.

It is further preferred to define a shared reference document and a corresponding set of 3D scene update documents when the size differences between any two of the set of 3D scene update documents are smaller than a second given threshold, for example a few kilobytes. In this case, if a processing engine needs to parse corresponding update documents through internet when triggered to access different scenes, it is possible to predict the downloading time precisely and make sure the document will be available in time, since each update document has similar size. Thus, an unnecessary 3D scene presentation delay or discontinuity resulted from the erroneously prediction of downloading time may be avoided, the user experience will be improved.

Alternatively, a shared reference document and a corresponding set of 3D scene update documents may be defined when the size of the at least one corresponding 3D scene update document for generating the at least one most popular target 3D scene among the set of target scenes is smaller than a third given threshold, for example few kilobyte, or minimized. Hence, the processing time to access the at least one most popular 3D scene will be limited or minimized.

In this embodiment, it is preferred to determine the at least one most popular 3D scene as the target scenes which appear more frequently than the other target 3D scenes. Alternatively, the most popular scenes might be determined as the targets scenes which are more likely to be triggered by an interaction event. For example, if the target 3D scene presentation describes a football game, target scenes containing goal moments are more likely to be chosen by the user. Additionally, the most popular scenes may also be determined when the interaction is available. In this case, the most popular target scenes may be the target scenes triggered more frequently by interactions of the users.

Since a shared reference document and a corresponding set of 3D update documents must be parsed altogether for generating the set of target 3D scenes, it is reasonable to encapsulate them into one file for better retrieving. Considering this, the encapsulated filed may be parsed to obtain the shared reference document the corresponding 3D scene update document for generating a target 3D scene.

Moreover, when a media file is immersed in the 3D scene presentation, the documents describing presentation may be encapsulated along with the media file directly. That is, all the 3D scene description documents, the shared reference documents and the 3D scene update documents may be encapsulated in a corresponding media file container.

In this embodiment, the media file may be a MPEG file, a shared reference document and a corresponding set of 3D update documents may be encapsulated in one ISOBMFF (ISO/IEC base media file format) container. Thus, a shared reference document may be encapsulated as an item or a sample in a track in the ISOBMFF file, while each corresponding 3D scene update document may be stored as a sample in a track in the ISOBMFF file. Optionally, a shared reference document and a first 3D scene update document among the set of corresponding 3D update documents may be stored as one item in the ISOBMFF file.

In a further embodiment, a first device with a processor is provided for presenting a set of target 3D scenes comprising:
a determining module determining that documents to be parsed for generating the set of target 3D scenes, namely a shared reference document and a corresponding set of 3D scene update documents for generating the set of target 3D scenes, are available,
wherein each target 3D scene among the set of target 3D scenes is described by a target 3D scene description document,
wherein a shared reference document describes part of the elements contained in the set of target 3D scene description documents,
wherein each 3D scene update document describes the updates applied to the shared reference document for generating the corresponding target 3D scene description document;
a triggering module triggering a presentation engine to present a target 3D scene among the set of target 3D scenes;
a presentation engine parsing the shared reference document and the corresponding 3D scene update document,
generating the target 3D scene description document, rendering the target 3D scene description document and updating the presenting scene as the target 3D scene.

In another embodiment, a second device with a processor applicable for presenting a set of target 3D scenes in a first device is provided. The device comprises a defining module 205 defining a shared reference document and a corresponding set of 3D update documents for generating a set of target 3D scenes, whereby the defined documents are applicable to be parsed in device 100 for generating a set of target 3D scenes.

In yet another embodiment, a system for presenting a set of target 3D scenes using a shared reference document and a corresponding set of 3D update document is provided.

### BRIEF DESCRIPTION OF THE DRAWINGS

FIG. 1 shows a scheme of a patching method of the prior art.

FIG. 2 shows a scheme for sequentially presenting 3D scenes as known from prior art.

FIG. 3 shows a method of presenting 3D scenes with a shared reference document, in embodiments.

FIG. 4 shows a first encapsulating format for storing a shared reference document and a corresponding set of 3D scene update document, in embodiments.

FIG. 5 shows a second encapsulating format, in embodiments.

FIG. 6 shows a third encapsulating format, in embodiments.

FIG. 7 shows a first device for presenting a set of target 3D scenes, in embodiments.

FIG. 8 shows a second device applicable for presenting a set of target 3D scenes by a first device, in embodiments.

FIG. 9 Shows a system for presenting a set of target 3D scenes, in embodiments.

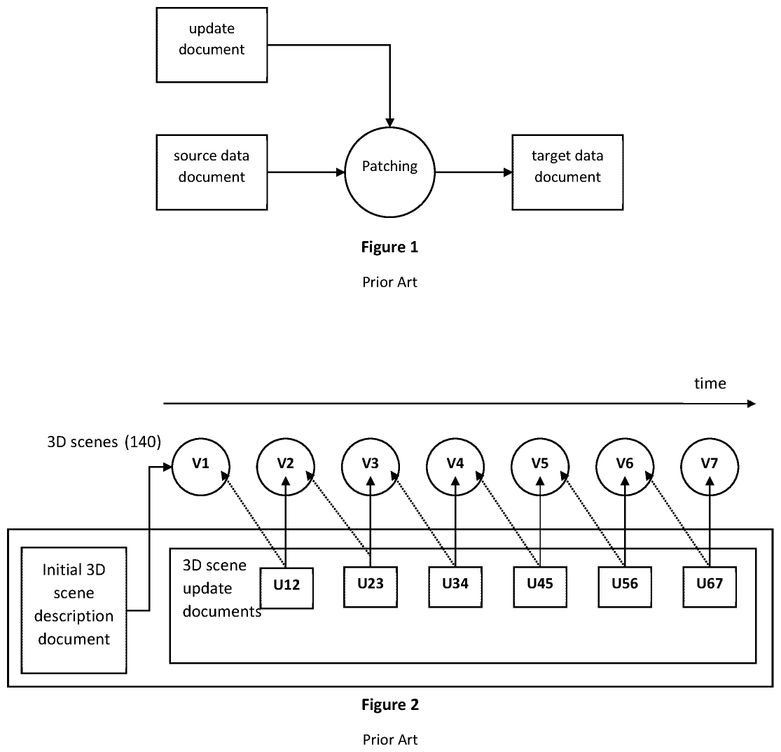

### DETAILED DESCRIPTION

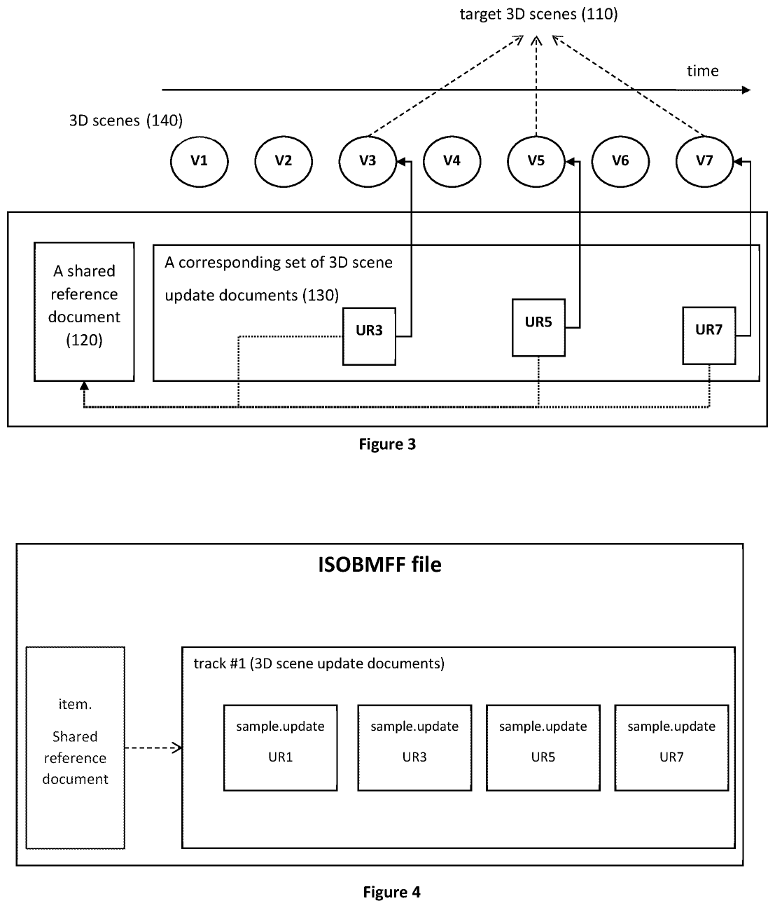

FIG. 3 shows a first embodiment of the present invention for updating a set of target 3D scenes (110) using a shared reference document (120) and a corresponding set of 3D scene update documents (130).

In a complete 3D scene presentation, there are a plurality of 3D scenes (140) V1, V2, V3, . . . to be presented sequentially. However, as depicted in FIG. 2, since updating of a latter scene is dependent on its preceding scene, it is impossible to start a 3D scene presentation in a 3D scene, for example (V2, V4, or V5 . . . ), which is not the initial scene V1. It is also impossible to skip some scenes, i.e. jump from V1 to V6 without presenting V2-V5. To address these drawbacks, the present invention provides a method for updating a set of target 3D scenes based on a shared reference document.

As depicted in FIG. 3, when updating a set of target 3D scenes (110) among a plurality of 3D scene (140) to be presented sequentially, it may be first determined whether the documents to be parsed for generating the set of target 3D scenes, namely a shared reference document (120) and a corresponding set of 3D scene update documents (130) for generating the set of target 3D scenes (110), are available; wherein each target 3D scene among the set of target 3D scenes (110) is described by a target 3D scene description document; a shared reference document describes part of the elements contained in the set of target 3D scene description documents; and each 3D scene update document describes the updates to be applied to the shared reference document (120) for generating the corresponding target 3D scene description document.

The set of target 3D scenes (110) may be denoted as random-access points of the 3D scene presentation and be determined according to certain strategies. For example, the target 3D scenes allowing random-access may be scenes which are particularly interesting to the user, i.e. goal moments in football matches, highlight moments in a movie and the like. The target 3D scenes may also be determined according to the presentation timeline, e.g. the scenes scheduled to be presented in the 5th, 10th, 15th . . . minute of the complete presentation. The set of target 3D scenes may contain part of the scenes to be presented, for example V3, V5 and V7; or all of the 3D scenes V1, V2, V3, . . . . For better understanding, the description is based on an example in which a set of target 3D scenes is determined as V3, V5 and V7. Nevertheless, the provided method can also be applied for any other composition of target 3D scenes. Moreover, when a 3D scene to be displayed is determined, the content of the associated 3D scene description document describing the scene should be also determined.

When a presentation engine is triggered to access or present a target 3D scene from the set of target 3D scenes after having determined that the shared reference document and the corresponding set of 3D update documents to be parsed for generating the set of target 3D scene are available, it parses the shared reference document (120) and the corresponding 3D scene update document to generate a 3D scene description document describing the triggered target 3D scene, renders the description document and update the presenting scene as the target 3D scene. Illustratively, when V3 is triggered to be accessed or presented, the shared reference document (120) and 3D scene update document UR3 are parsed by the presentation engine. The updates contained in UR3 are applied to the shared reference document (120). Thus, a complete 3D scene description document describing V3 is generated and rendered; the target 3D scene V3 is presented to the user.

The presentation engine may be triggered by any signal of the wall-clock time, presentation time or interaction event and so on. In an implementation of this embodiment wherein the trigger signal is wall-clock time, when the wall-clock time indicates night, e.g 10 p.m., a 3D night scene may be presented; when the wall-clock time is 6 a.m., a 3D sun-rising scene may be displayed.

It is further preferred to define a shared reference document (120) and a corresponding set of 3D scene update documents (130) for generating the set of target 3D scenes according to certain criteria before the availability determination. For this consideration, a candidate shared refence document may be generated based on the contents of the set of 3D scene description documents describing the set of target 3D scenes (110). Specifically, a candidate shared reference document may describe all the common elements described in each target 3D scene description documents; describe the elements appearing more than one time in all target 3D scene description documents, or describe random element containing in the set of target 3D scene description documents.

Moreover, the candidate shared reference document may not be a complete 3D scene description document or even a synthetically valid 3D scene description document, but only formulated in the same data format supporting a patching method, e.g. JSON or XML data format, since the only requirement for applying a patching method is the data format. To be more specific, a presentation engine may be unable to present a 3D scene by solely parsing a shared reference document. However, a presentation engine can update a shared reference document according to a 3D scene update document for generating a complete 3D scene description document which can be rendered for presenting a 3D scene.

When a candidate shared reference document and the set of target 3D scene description documents are known, a corresponding set of candidate 3D scene update documents may therefore be computed based on them. Each corresponding 3D scene update document is computed based on the differences between the candidate shared reference document and one of the target 3D scene description documents. Concretely, a candidate 3D scene update document describes the update operations applied to the candidate 3D scene update document for generating a complete target 3D scene description document. If the 3D scene description document and the candidate shared reference document are formulated in JSON, the 3D update document will be a JSON patch document, e.g. as defined in IETF® RFC 6902, JavaScript® Object Notation (JSON) Patch document.; if they are formulated in XML, the 3D update document will be an XML diff document or a XML patch document as defined in IETF® RFC 5621—An Extensible Markup Language (XML) Patch Operations Framework Utilizing XML Path Language (XPath) Selectors.

After a set of candidate 3D scene update document is computed, a certain criterion may be applied for determining whether the candidate shared reference document and its associated set of candidate 3D scene update document should be employed for generating the set of target 3D scenes.

In a preferred embodiment, the overall size of the candidate set of all 3D scene update documents may be calculated. Only if the overall size is smaller than a first given threshold, for example, a few megabytes or hundred kilobytes, the candidate shared reference document and its corresponding set of candidate 3D scene update documents will be defined respectively as the shared reference document and the corresponding set of 3D scene update documents for generating the set of target 3D scenes. Otherwise, a new candidate shared reference document will be generated and evaluated accordingly until a suitable shared reference document is determined.

Optionally, the evaluation criteria may also be the size differences between any two of size differences between any two of the set of candidate 3D scene update documents. Only if all of the size differences are smaller than a second given threshold, for example a few kilobytes, the candidate shared reference documents and its corresponding set of candidate 3D scene update documents will be defined respectively as the shared reference document and the corresponding set of 3D scene update documents for generating the set of target 3D scenes. By satisfy this criterion, all the corresponding 3D scene update documents may have similar sizes.

Alternatively, a shared reference document and a corresponding set of 3D scene update documents may be defined when the sizes of certain candidate 3D scene update documents are smaller than a third threshold. Specifically, only if the sizes of the corresponding 3D scene update documents for generating some most popular target 3D scenes are smaller than a third given threshold, for example few kilobyte, or minimized; the candidate shared reference document and its corresponding set of candidate 3D scene update documents may be chosen for realizing the generation. Moreover, the number of most popular target 3D scenes may be smaller than the total number of different scenes of the set of target scenes, each most popular target scene should be different from another.

In this embodiment, it is preferred to determine the at least one most popular 3D scene as the target scenes which appear more frequently than the other target 3D scenes. For example, when the set of target 3D scenes consists of V2, V3, V5 and V7; V3 and V7 describe the same 3D scenes, e.g. the 3D scene description documents describing V3 and V7 are identical. Thus, V3 and V7 will be determined as the most popular target 3D scenes.

Optionally, the most popular scenes might be determined as the targets scenes which are more likely to be triggered by interaction event. For example, if the target 3D scene presentation describing the evolution of the universe, target scenes containing the big bang, or the birth of the earth may be more likely to be chosen by the user and should be determined as the most popular target 3D scenes.

Additionally, the most popular scenes may also be determined when data about earlier interactions by users is available. To be more specific, if an earlier version of this 3D scene presentation is published, and the feedback collected demonstrates that certain scenes are more frequently triggered by the user, then they should be determined as the most popular target scenes. Moreover, they can be applied as the criteria for realizing random-access function for a latter version of this 3D scene presentation.

It is optional to encapsulate a shared reference document and a corresponding set of 3D scene update documents into one file and publish it as supplementary or a plug-in for the original 3D presentation file without random-access. Therefore, a user can decide whether to download it or not for using the random-access function. It is also optional to encapsulate a shared reference document and a corresponding set of 3D scene update documents along into the original 3D scene presentation file.

In both cases, parsing the shared reference document and the corresponding 3D scene update document further comprises parsing the encapsulated file in which the shared reference document and the corresponding 3D scene update document is extracted from the encapsulated file for further processing.

Moreover, when a media file is immersed in the 3D scene presentation, the documents describing presentation information may be provided along with immersed media file or be encapsulated into the media file directly. That is, all the 3D scene description documents, the shared reference documents and the 3D scene update documents may be encapsulated in a corresponding media file container.

In a preferred embodiment, the media file may be a MPEG media, a shared reference document and a corresponding set of 3D update documents may be encapsulated in one ISOBMFF (ISO/IEC base media file format) container. The MPEG media includes but is not limited to media encoded with MPEG codecs, media stored in MPEG containers, MPEG media and application formats as well as media provided through MPEG delivery mechanisms. The 3D scene presentation documents may also be encapsulated in other media file containers, for example, Matroska® or AVI.

In a preferred embodiment when a shared reference document and a corresponding set of 3D update documents are encapsulated in an ISOBMFF file, the shared reference document might be stored as an untimed item in the ISOBMFF file while each corresponding 3D scene update document is stored as a sample in a track of the ISOBMFF file.

In a specific implementation of this embodiment, the immersed media is a MPEG media, complete 3D scene description documents are a JSON based gITF® (Graphics Language Transmission Format) files. The shared reference document is also a JSON document and may be stored with an ISOBMFF structure as depicted in Table 1 below.

The shared reference document may be denoted as JSR file, the 3D update document may be denoted as JSON patch file.

TABLE 1

| Level n | Level n + 1 | Level n + 2 | Note |
|---|---|---|---|
| meta | | | MetaBox |
| | hdlr: | | HandlerBox with the handler |
| | handler_type = gltp | | ‘gltp’ which means that this |
| | | | MetaBox contains a JSON file |
| | | | from which a glTF file can be |
| | | | generated by applying a JSON |
| | | | patch. |
| | pitm: | | item_ID value is arbitrary |
| | item_ID = 0 | | chosen but must refer to an |
| | | | item_ID present in |
| | | | ItemLocationBox below. |
| | iinf: | | ItemInfoBox with |
| | entry_count = 1 | | entry_count which means |
| | | | one child ItemInfoEntry |
| | | | present. |
| | | infe: | ItemInfoEntry with |
| | | item_ID = 0 | item_name set to |
| | | item_name = ref. json | ref.json.content_type |
| | | content_type = ‘application/json’ | is declared as a JSON file and |
| | | | not as a glTF file since the JSR |
| | | | file may not be a valid glTF in |
| | | | order to minimize the patch |
| | | | sizes. |
| | | | ‘application/json’ is a |
| | | | defined MIME type registered |
| | | | by RFC4627. |
| | iloc: | | The item is stored in the idat |
| | item_count = 1 | | box. |
| | loop over | | data_reference_index is |
| | item_count | | equal to 0 which means ‘this |
| | item_ID = 0 | | file’ as specified in ISOBMFF. |
| | construction_method = 1 | | extent_length is set to |
| | data_reference_index = 0 | | 321 as an example size in bytes |
| | extent_count = 1 | | of the JSR file. |
| | loop over | | |
| | extent_count | | |
| | extent_offset = 0 | | |
| | extent_length = 300 | | |
| | idat: | | ItemDataBox |
| | data = (JSR bytes) | | |

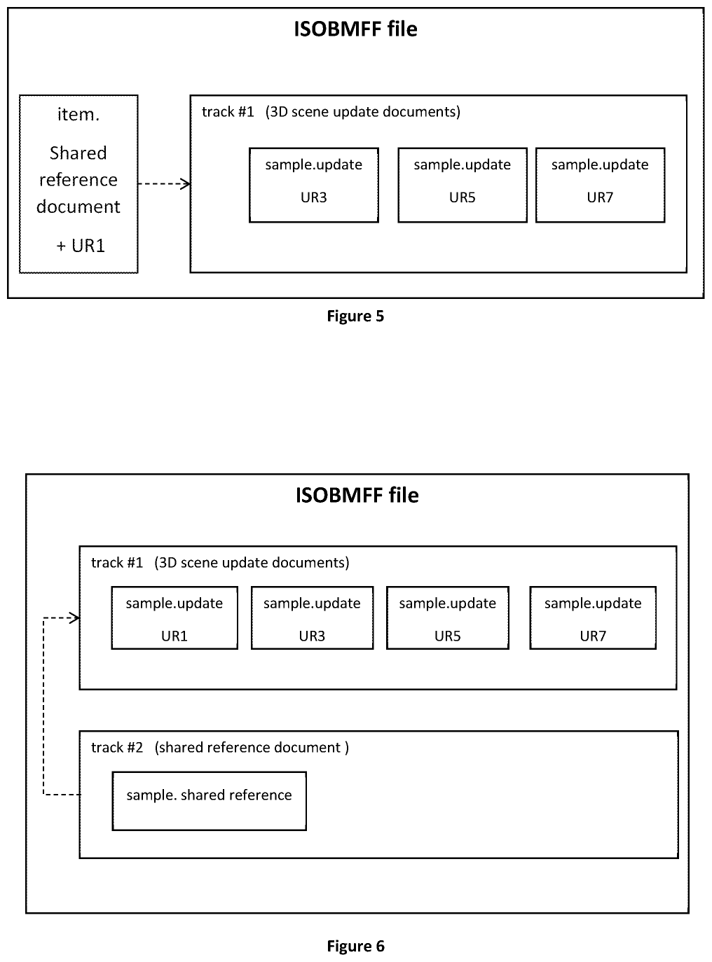

Optionally, if the initial 3D scene V1 for starting the presentation is also included in the set of target 3D scenes, both the shared reference documents and the first corresponding 3D update documents UR1 may be stored as one untimed item in the ISOBMFF file as depicted in FIG. 5.

In a specific implementation of this embodiment, the immersed media is a MPEG media, complete 3D scene description documents are a JSON based gITF (Graphics Language Transmission Format) files. The shared reference document is also a JSON document, each corresponding 3D update scene documents is a JSON patch document. The shared reference document and a 3D update scene document may be stored together as one item with an ISOBMFF structure as depicted in Table 2 below. The shared reference document may be denoted as JSR file, the 3D update document may be denoted as JSON patch file.

TABLE 2

| Level n | Level n + 1 | Level n + 2 | Note |
|---|---|---|---|
| meta | | | MetaBox |
| | hdlr: | | |
| | handler_type = gltp | | |
| | pitm: | | |
| | item_ID = 0 | | |
| | iinf: | | ItemInfoBox with |
| | entry_count = 2 | | entry_count which |
| | | | means two children |
| | | | ItemInfoEntry |
| | | | present. |
| | | infe: | ‘application/json- |
| | | item_ID = 0 | patch + json’ is a |
| | | item_name = ref.json | defined MIME type |
| | | content_type = | registered by RFC6902. |
| | | ‘application/json’ | |
| | | infe: | |
| | | item_ID = 1 | |
| | | item_name = patch1.json | |
| | | content_type = ‘application/json- | |
| | | patch + json’ | |
| | iloc: | | |
| | item_count = 2 | | |
| | loop over | | |
| | item_count | | |
| | item_ID = 0 | | |
| | construction_method = 1 | | |
| | data_reference_index = 0 | | |
| | extent_count = 1 | | |
| | loop over | | |
| | item_count | | |
| | extent_offset = 0 | | |
| | extent_length = 321 | | |
| | item_ID = 1 | | |
| | construction_method = 1 | | |
| | data_reference_index = 0 | | |
| | extent_count = 1 | | |
| | loop over | | |
| | extent_count | | |
| | extent_offset = 321 | | |
| | extent_length = 112 | | |
| | iref: | | ItemReferenceBox |
| | | SingleItemTypeReferenceBox | ReferenceType |
| | | (referenceType = ‘patch’): | ‘patch’ to specify that |
| | | from_item_ID = 1 | an item is a patch to be |
| | | reference_count = 1 | applied to another item. |
| | | loop over | By convention we define |
| | | reference_count | that the from-item is the |
| | | to_item_ID = 0 | patch and the document |
| | | | patched is the to-item. |
| | | | Note that the patch |
| | | | reference type as |
| | | | defined could be used |
| | | | for other types of patch |
| | | | mechanism. |
| | idat: | | ItemDataBox |
| | data = (JSR bytes + | | This box now contains |
| | JSON patch bytes) | | the JSR file and right |
| | | | after the JSON patch. |

It is also possible to store the shared reference document as a sample in a track of an ISOBMFF file as shown in FIG. 6.

In a further implementation, the immersed media is a MPEG media, complete 3D scene description documents are a JSON based gITF (Graphics Language Transmission Format) files. The shared reference document is also a JSON document and may be stored as a sample in a track with an ISOBMFF structure as depicted in Table 3 below. The shared reference document may be denoted as JSR file, the 3D update document may be denoted as JSON patch file.

TABLE 3

| Level N | Note |
|---|---|
| . . . | Any common box but not |
| | relevant for invention. Only |
| | the boxes and the fields of |
| | the boxes relevant for the |
| | invention are represented |
| | below. |
| mett: | This MIME format specifies |
| mime_format = ‘application/ | that thes amples contain JSON |
| mpeg-gltf-patch-target + json’ ’ | files and that after patching, |
| | they result in valid glTF files. |

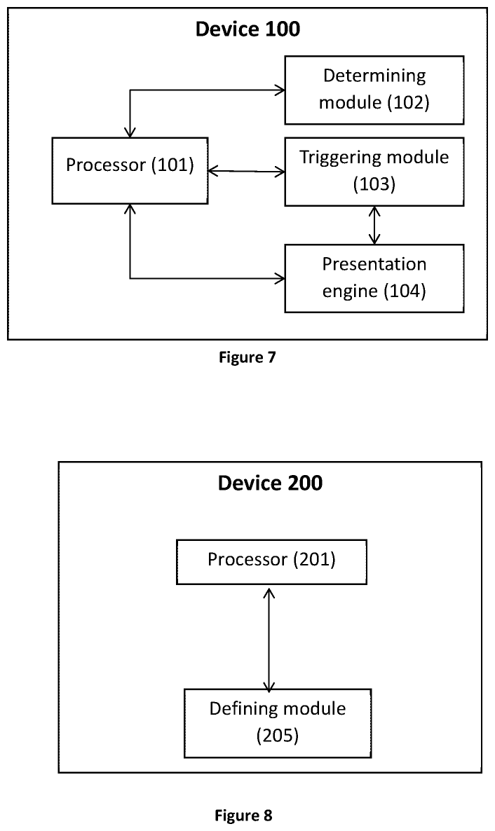

FIG. 7 shows a device (100) with a processor (101) for presenting a set of target 3D scenes. The device (100) comprises a determining module (102) determining that documents to be parsed for generating the set of target 3D scenes, namely a shared reference document and a corresponding set of 3D scene update documents for generating the set of target 3D scenes are available; wherein each target 3D scene among the set of target 3D scenes is described by a target 3D scene description document; a shared reference file describes part of the elements contained in the set of target 3D scene description documents, each 3D scene update document describes the updates to be applied to the shared reference document for generating the corresponding target 3D scene description document.

The first device (100) further comprises a triggering module (103) triggering a presentation engine to present a target 3D scene among the set of target 3D scenes.

The first device (100) also comprises a presentation engine (104) parsing the shared reference document and the corresponding 3D scene update document, generating the target 3D scene description document, rendering the target 3D scene description document and updating the presenting scene as the target 3D scene. The first device (100) may also be a media player.

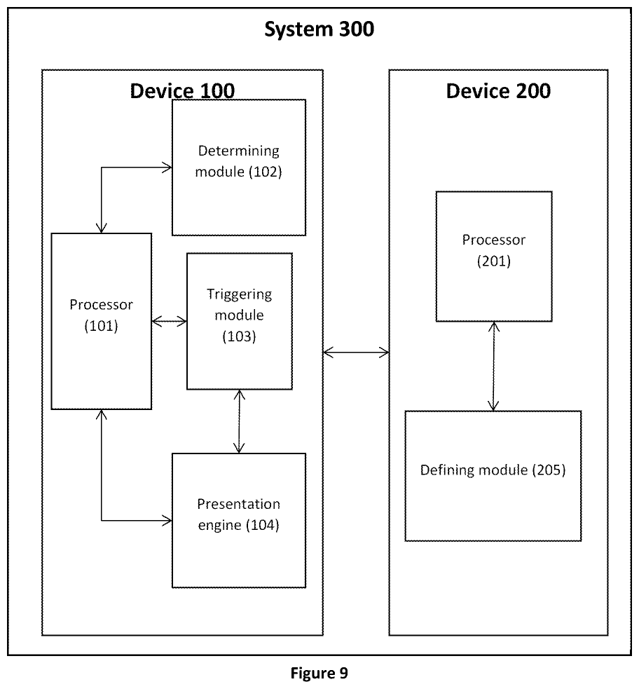

FIG. 8 shows a second device (200) with a processor (201) applicable for presenting a set of target 3D scenes in a first device (100). The second device (200) comprises a defining module (205) defining a shared reference document and a corresponding set of 3D update documents for generating a set of target 3D scenes, whereby the defined documents are applicable to be parsed in a first device (100) for generating a set of target 3D scenes. The second device (200) may also be a media content creating device. FIG. 9 shows a system comprising a device (100) and a device (200) for presenting a set of target 3D scenes in device (100) using a shared reference document and a corresponding set of 3D update documents defined by device (200).

1. A 3D scene updating method for presenting a set of target 3D scenes by
a presentation engine, comprising:
determining that documents to be parsed for generating a set of target 3D scenes, namely a shared reference document and a corresponding set of 3D scene update documents for generating the set of target 3D scenes, are available,
wherein each target 3D scene among the set of target 3D scenes is described by a target 3D scene description document,
wherein a shared reference document describes part of the elements contained in the set of target 3D scene description documents,
wherein each 3D scene update document describes the updates applied to the shared reference document for generating the corresponding target 3D scene description document;
triggering the presentation engine to present a target 3D scene among the set of target 3D scenes;
parsing the shared reference document and the corresponding 3D scene update document;
generating the target 3D scene description document;
rendering the target 3D scene description document and updating the presenting scene as the target 3D scene.

2. The method of claim 1,
wherein a shared reference document is different from a 3D scene description document.

3. The method of claim 1, wherein triggering the presentation engine to present a target 3D scene among the set of target 3D scenes comprising:
triggering the presentation engine by at least one of the wall-clock time, presentation time or interaction event.

4. The method of claim 1 further comprising:
defining a shared reference document and a corresponding set of 3D scene updates documents for generating the set of target 3D scenes.

5. The method of claim 4,
wherein defining a shared reference document and a corresponding set of 3D scene updates documents for generating the set of target 3D scenes comprising:
generating a candidate shared reference document;
computing a set of candidate 3D scene update documents for generating the set of target 3D scene documents;
calculating the overall size of the candidate set of 3D scene update documents;
if the overall size is smaller than a first given threshold,
defining the candidate shared reference document as the shared reference document, the candidate set of 3D scene documents as the corresponding set of 3D scene documents for generating the set of target 3D scenes.

6. The method of claim 4,
wherein defining a shared reference document and a corresponding set of 3D scene updates documents for generating the set of target 3D scenes comprising:
generating a candidate shared reference document;
computing a set of candidate 3D scene update documents for generating the set of target 3D scene documents;
calculating the size differences between any two of the candidates set of 3D scene update documents;
if all of size differences are smaller than a second given threshold,
defining the candidate shared reference document as the shared reference document, the candidate set of 3D scene documents as the corresponding set of 3D scene documents for generating the set of target 3D scenes.

7. The method of claim 4,
wherein defining a shared reference document and a corresponding set of 3D scene updates documents for generating the set of target 3D scenes comprising:
generating a candidate shared reference document;
computing a candidate plurality of 3D scene update documents for generating the plurality of target 3D scene documents;
determining at least one most popular target 3D scene description document among the set of target 3D scene documents;
calculating the size of the at least one candidate 3D scene update document for generating the at least one most popular target 3D scene description document;
if all the sizes are smaller than a third given threshold,
defining the candidate shared reference document as the shared reference document, the candidate set of 3D scene documents as the set 3D scene documents for generating the target 3D scene.

8. The method of claim 7,
wherein determining at least one most popular target 3D scene description document among the set of target 3D scene documents comprising:
determining at least one target 3D scene description document describing a target 3D scene which appears most frequently among the set of target 3D scenes as the at least one most popular target 3D scene description documents; or
determining at least one target 3D scene description document describing a target 3D scene which is most likely to be triggered by interaction event as the at least one most popular target 3D scene description documents; or
determining at least one target 3D scene description document describing a target 3D scene, among the set of target 3D scenes, which is most frequently triggered by interaction event as the at least one most popular target 3D scene description documents.

9. The method of claim 1,
wherein defining a shared reference document and a corresponding set of 3D scene update documents for generating the set of target 3D scenes further comprising:
encapsulating the documents into one file to be parsing in the presentation engine; and

10. The method of claim 9, wherein the documents are encapsulated in an ISOBMFF file, and
the shared reference document is encapsulated as an item in the ISOBMFF file.

11. The method of claim 9, wherein the documents are encapsulated in an ISOBMFF file, and
the shared reference document and the corresponding 3D scene update document are encapsulated as one item in the ISOBMFF file.

12. The method of claim 9, wherein the documents are encapsulated in an ISOBMFF file, and
the shared reference document is encapsulated as a sample in a track of the ISOBMFF file.

13. The method of claim 1,
wherein a shared reference document is a JSON document, a 3D scene description document is a gITF document, a 3D scene update document is a JSON patch file; or
wherein a shared reference document and a 3D scene description document are XML document, a 3D scene update document is an XML diff file or an XML patch document.

14. A first device 100 with a processor (101) for presenting a set of target 3D scenes in a presentation engine comprising:
a determining module (102) determining that documents to be parsed for generating a set of target 3D scenes, namely a shared reference document and a corresponding set of 3D scene update documents for generating the set of target 3D scenes, are available,
wherein each target 3D scene among the set of target 3D scenes is described by a target 3D scene description document,
wherein a shared reference document describes part of the elements contained in the set of target 3D scene description documents,
wherein each 3D scene update document describes the updates applied to the shared reference document for generating the corresponding target 3D scene description document;
a triggering module (103) triggering a presentation engine to present a target 3D scene among the set of target 3D scenes;
a presentation engine (104) parsing the shared reference document and the corresponding 3D scene update document,
generating the target 3D scene description document,
rendering the target 3D scene description document and updating the presenting scene as the target 3D scene.

15. A second device (200) with a processor (201) applicable for presenting a set of target 3D scenes by a first device (100), the second device comprising:
a defining module (205) defining a shared reference document and a corresponding set of 3D update documents for generating a set of target 3D scenes,
whereby the defined documents are applicable to be parsed in a first device (100) for generating a set of target 3D scenes.

16. A system (300) for presenting a set of target 3D scenes comprising:
a first device (100) according to claim 14; and
a second device (200)—with a processor (201) applicable for presenting a set of target 3D scenes by the first device (100), the second device comprising:
a defining module (205) defining a shared reference document and a corresponding set of 3D update documents for generating a set of target 3D scenes,
whereby the defined documents are applicable to be parsed in the first device (100) for generating a set of target 3D scenes.
